(19) United States
(12) Patent Application Publication
(10) Pub. No.: US 2024/0177181 A1
(43) Pub. Date: May 30, 2024

(54) DEMAND PREDICTION DEVICE, DEMAND PREDICTION METHOD, AND RECORDING MEDIUM

(71) Applicants: NEC Corporation, Tokyo (JP); NEC Solution Innovators, Ltd., Tokyo (JP)

(72) Inventors: Naoki WASHIZUKA, Tokyo (JP); Kyohko AKAZAWA, Tokyo (JP)

(73) Assignees: NEC Corporation, Tokyo (JP); NEC Solution Innovators, Ltd., Toyko (JP)

(21) Appl. No.: 18/515,721

(22) Filed: Nov. 21, 2023

(30) Foreign Application Priority Data
Nov. 28, 2022 (JP) 2022-188844

(51) Int. Cl. G06Q 30/0202; G06Q 10/0631

(52) U.S. Cl. CPC G06Q 30/0202; G06Q 10/06315

(57) ABSTRACT

A demand prediction device of the present disclosure includes an information acquisition means that acquires deviation information indicating a deviation from an actual demand of a target product and a sales quantity, a correction means that corrects the sales quantity based on the deviation information, and a generation means that generates a demand prediction model based on learning data including the corrected sales quantity.

This application is based upon and claims the benefit of priority from Japanese Patent Application No. 2022-188844, filed on Nov. 28, 2022, the disclosure of which is incorporated herein in its entirety by reference.

### TECHNICAL FIELD

The present disclosure relates to a demand prediction device, a demand prediction method, and a recording medium.

### BACKGROUND ART

A method of learning a prediction model based on past product sales results and performing future demand prediction based on the prediction model is widely known. For example, PTL 1 (PCT International Publication No. WO 2019/203184) discloses a product demand prediction device considering an increase in the number of products sold due to a bargain price. PTL 2 (PCT International Publication No. WO 2019/159772) discloses a model generation device that generates a demand prediction model and calculates a prediction value based on demand information indicating the number of products sold in a store in a past predetermined period, and external information and the number of displays related to the number of products sold.

### SUMMARY

An object of the present disclosure is to provide a demand prediction device capable of enhancing accuracy of demand prediction of a product.

According to an aspect of the present disclosure, there is provided a demand prediction device including an information acquisition means that acquires deviation information indicating a deviation from an actual demand of a target product and a sales quantity, a correction means that corrects the sales quantity based on the deviation information, and a generation means that generates a demand prediction model based on learning data including the corrected sales quantity.

According to another aspect of the present disclosure, there is provided a demand prediction method for causing a computer to execute acquiring deviation information indicating a deviation from an actual demand of a target product and a sales quantity, correcting the sales quantity based on the deviation information, and generating a demand prediction model based on learning data including the corrected sales quantity.

According to still another aspect of the present disclosure, there is provided a program for causing a computer to execute acquiring deviation information indicating a deviation from an actual demand of a target product and a sales quantity, correcting the sales quantity based on the deviation information, and generating a demand prediction model based on learning data including the corrected sales quantity.

### BRIEF DESCRIPTION OF THE DRAWINGS

Exemplary features and advantages of the present invention will become apparent from the following detailed description when taken with the accompanying drawings in which:

FIG. 1 is a diagram illustrating a configuration including a demand prediction device according to the present disclosure;

FIG. 2 is a diagram illustrating a hardware configuration in which the demand prediction device according to the present disclosure is achieved by a computer device and a peripheral device of the computer device;

FIG. 3 is a flowchart illustrating an operation of demand prediction in the present disclosure;

FIG. 4 is a diagram illustrating a configuration including a demand prediction device according to the present disclosure;

FIG. 5 is an example of a screen for calculating a quantity of missing products in the present disclosure; and

FIG. 6 is a flowchart illustrating an operation of demand prediction in the present disclosure.

### EXAMPLE EMBODIMENT

First, an outline of a demand prediction device 100 according to an example embodiment of the present invention will be described. The demand prediction device 100 includes at least an information acquisition means that acquires deviation information indicating a deviation from an actual demand of a target product and a sales quantity, a correction means that corrects the sales quantity based on the deviation information, and a generation means that generates a demand prediction model based on learning data including the corrected sales quantity. According to this configuration, the demand prediction device 100 generates the demand prediction model based on the learning data including the corrected sales quantity based on the deviation information. Therefore, when the demand of the product is predicted using the generated demand prediction model, accuracy of the demand prediction can be improved.

### First Example Embodiment

The demand prediction device 100 according to the present example embodiment is a device for performing demand prediction of a product to be sold at a retail store, such as food items such as fresh food items and daily necessities, or household goods. As a specific example of the present example embodiment, it is assumed that prediction is performed as a sales quantity indicating how much a certain store sells a product (hereinafter, referred to as a target product) to be predicted. The demand prediction device 100 may be configured as an ordering system capable of placing an order for the number of target products necessary for the store based on the predicted sales quantity.

In the present disclosure, as the demand prediction target period, for example, a predetermined period such as one day or one week, a period corresponding to an order interval, or the like is considered. The present disclosure will be mainly described assuming a case where a daily sales quantity of a target product in a specific store is predicted.

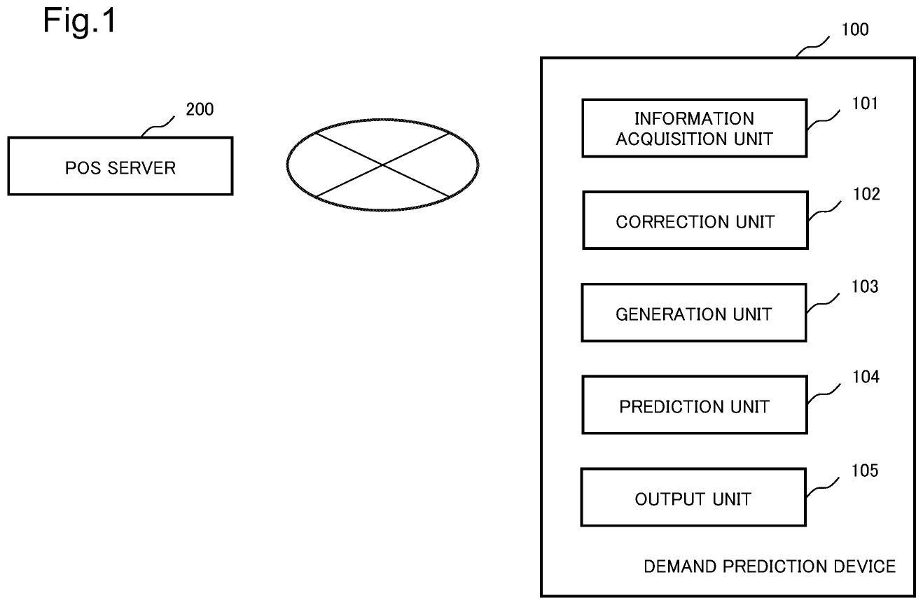

FIG. 1 is a diagram illustrating a configuration including the demand prediction device 100 according to the present disclosure. Referring to FIG. 1, the demand prediction device 100 acquires data necessary for demand prediction from a point of sale (POS) server 200 through a network.

For example, the POS server 200 stores product sales performance information. The sales performance information of the product includes a name of the product sold, a sales date and time, a sales store, and a sales quantity. The POS server 200 stores a quantity sold as a parting product for each product. For example, when predicting the sales quantity on a daily basis, the demand prediction device 100 acquires learning data including at least a daily sales quantity of the target product from several days to several tens of days before a prediction target date from the POS server 200, and generates a demand prediction model.

As the learning data, an actual value of the past sales quantity for each product is used. For example, when “∘∘ yogurt of A company” is a target product, the demand prediction device 100 uses, for example, an actual value of a sales quantity of the same product (that is, ∘∘ yoghurt of A company) of the same manufacturer as the learning data.

When the data of the sales quantity of the same product is small, the demand prediction device 100 may use the sales quantity of the same product of a manufacturer of another company or a product included in the same category as the learning data.

As illustrated in FIG. 1, the demand prediction device 100 includes an information acquisition unit 101, a correction unit 102, a generation unit 103, a prediction unit 104, and an output unit 105. Next, a configuration of the demand prediction device 100 according to the present disclosure will be described in detail.

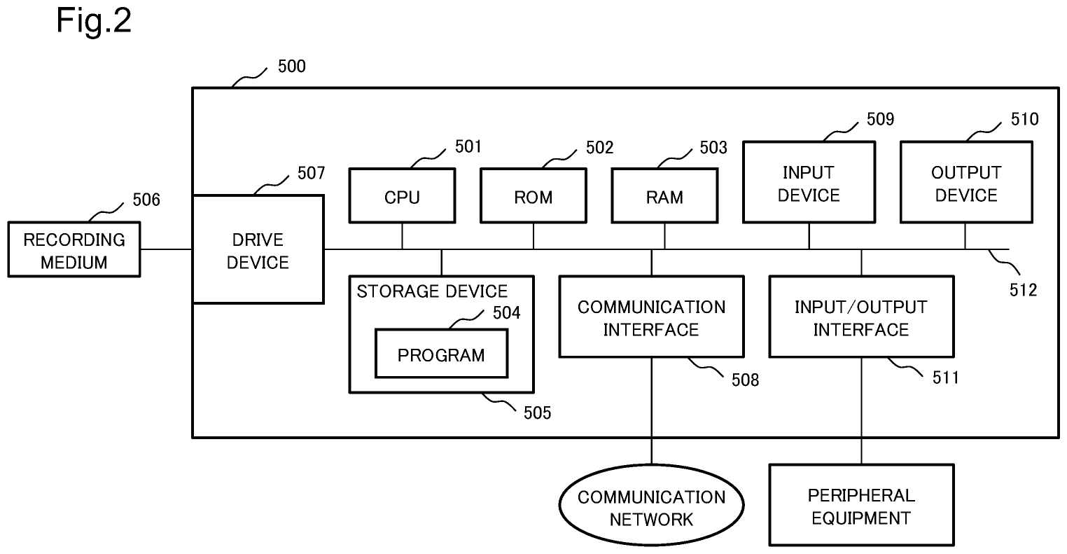

FIG. 2 is a diagram illustrating an example of a hardware configuration in which the demand prediction device according to the present disclosure is achieved by a computer device 500 including a processor. As illustrated in FIG. 2, the demand prediction device 100 includes a memory such as a central processing unit (CPU) 501, a read only memory (ROM) 502, and a random access memory (RAM) 503, a storage device 505 such as a hard disk that stores a program 504, a communication interface (I/F) 508 for network connection, and an input/output interface 511 that inputs and outputs data. In the present disclosure, deviation information and the sales quantity received from the POS server 200 are input to the demand prediction device 100 via the communication I/F 508 for network connection.

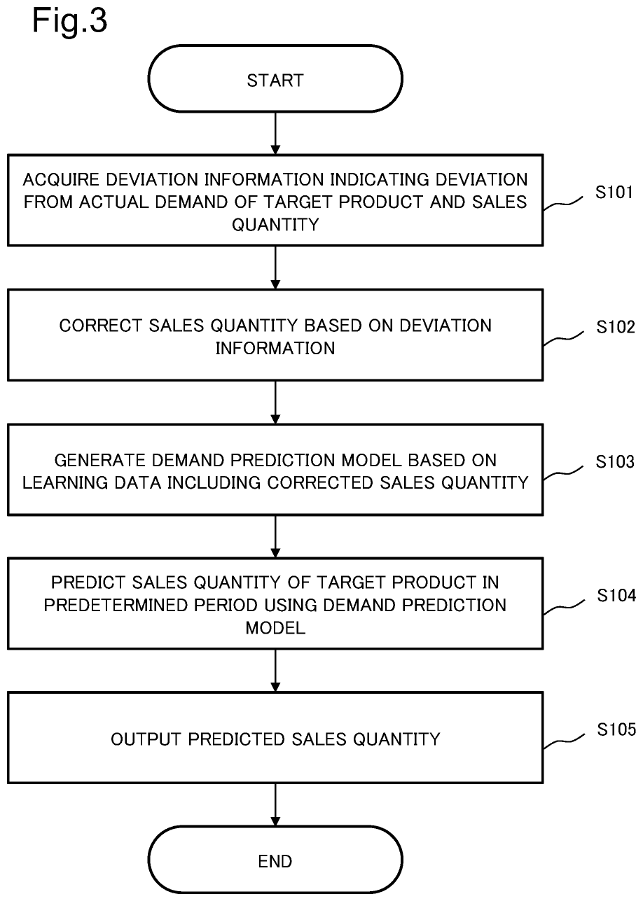

The CPU 501 operates an operating system to control the entire demand prediction device 100 according to the present disclosure. The CPU 501 reads a program and data from a recording medium 506 mounted on a drive device 507 or the like to a memory, for example. The CPU 501 functions as the information acquisition unit 101, the correction unit 102, the generation unit 103, the prediction unit 104, the output unit 105, and a part thereof in the present disclosure, and executes processing or a command in the flowchart illustrated in FIG. 3 described later based on a program.

The recording medium 506 is, for example, an optical disk, a flexible disk, a magnetic optical disk, an external hard disk, a semiconductor memory, or the like. A part of the recording medium of the storage device is a non-volatile storage device, and records a program therein. The program may be downloaded from an external computer (not illustrated) connected to a communication network.

The input device 509 is achieved by, for example, a mouse, a keyboard, a built-in key button, and the like, and is used for an input operation. The input device 509 is not limited to a mouse, a keyboard, and a built-in key button, and may be, for example, a touch panel. The output device 510 is achieved by, for example, a display, and is used to confirm an output.

As described above, the present disclosure illustrated in FIG. 1 is achieved by the computer hardware illustrated in FIG. 2. However, means for achieving each unit included in the demand prediction device 100 in FIG. 1 is not limited to the configuration described above. Further, the demand prediction device 100 may be achieved by one physically coupled device, or may be achieved by a plurality of device obtained by connecting physically separated two or more devices by wire or wirelessly. For example, the input device 509 and the output device 510 may be configured as a system connected to the computer device 500 via a network. The demand prediction device 100 according to the present disclosure illustrated in FIG. 1 can also be configured by cloud computing or the like.

The information acquisition unit 101 is a unit that acquires deviation information indicating a deviation from an actual demand of the target product and a sales quantity. The actual demand is the sales quantity of the product that could have been sold at a normal price, and includes a virtual sales quantity that would have been able to be sold when there is stock in a case where there is no stock. The normal price is a predetermined price such as a regular price, and is a price at which no price increase or discount is made. The sales quantity refers to an actual value of the sales quantity that is actually sold, and also includes the sales quantity of a parting product.

The deviation information is, for example, the quantity of the parting product or a missing product of the target product. The parting product is a product sold at a price lower than the normal price. The parting product may be limited to a product sold at a predetermined discount rate or more (for example, 30% discount or more). For example, the user may set a threshold of a discount rate as to whether the product is included in actual demand, such as the product being included in the sales quantity (actual demand) when the discount rate is 20% lower than the normal price, and the product being included in the parting product when the discount rate is 50% lower than the normal price. The information acquisition unit 101 may perform the calculation by learning a threshold of an appropriate discount rate. The missing product is a product that is considered to be sold when there is stock during the operation of the store.

The information acquisition unit 101 acquires the deviation information and the sales quantity of the target product. Specifically, the information acquisition unit 101 acquires, from the sales performance information stored in the POS server 200, the quantity of the parting product of the target product and the actual value of the sales quantity. The information acquisition unit 101 acquires information on the quantity of the missing product based on the actual value of the sales quantity of the target product. The quantity of the missing product refers to, for example, a quantity when the actual value of the sales quantity at that time point is subtracted from a theoretical stock before a business hour on a business day and the stock becomes 0 or less. In the present disclosure, the theoretical stock is calculated by the ordering system. Specifically, the ordering system acquires the actual value of the sales quantity from the POS server 210, and information of product disposal, movement information (inter-store movement or the like), and the order quantity from a core system of the head office that manages each store, and calculates and holds the theoretical stock using these pieces of information. The theoretical stock refers to the stock quantity of the theoretical value in the store calculated from the above-described information registered in the POS server 210 and the core system, and information that is not registered in the core system is not reflected.

The correction unit 102 is a unit that corrects the sales quantity based on the deviation information. The correction unit 102 corrects the sales quantity from the actual value of the sales quantity of the target product in consideration of the quantity of the parting product and the quantity of the missing product. Specifically, the correction unit 102 subtracts the quantity of the parting product from the actual value of the sales quantity of the target product. The correction unit 102 adds the quantity of the missing product to the sales quantity of the target product. The correction unit 102 outputs the sales quantity thus corrected to the generation unit 103.

The generation unit 103 is a unit that generates a demand prediction model based on learning data including the corrected sales quantity. When the sales quantity corrected by the correction unit 102 is input, the generation unit 103 generates the demand prediction model using the corrected sales quantity as learning data. In the present disclosure, the generation unit 103 generates a prediction model for each store and each product.

The generation unit 103 generates each prediction model by machine learning using the corrected sales quantity of the past target product as teacher data. The model generated by the generation unit 103 may be any model as long as the sales quantity is an objective variable and the objective variable is represented by a prediction expression using an explanatory variable, and the content of the prediction expression (prediction model) is arbitrary. As the explanatory variable, a variable corresponding to a factor that affects the sales quantity is used.

The factor is, for example, calendar information (weekday/holiday, day of week) of the demand prediction target date, weather information (highest temperature, lowest temperature, weather), or information of past results such as the number of customers or the sales quantity. As the factor, for example, a sales promotion activity (campaign) such as a discount, an event (neighborhood event) held near a store, an event (special event) held in a store, an advertisement in media such as a television and a magazine, and a special factor occurring before or after a demand prediction target date such as an introduction article (CM/media) may be included. However, the factor is not limited thereto as long as it is information that affects the sales quantity and the number of customers.

The factor information may be received an input from the user, may read information stored in advance in the storage device 505, or may be acquired from another device such as the POS server 200 or an external system (not illustrated) via a network. The generation unit 103 may calculate a moving average or the like using the number of customers or the sales quantity acquired from another device, and use the calculated value as an explanatory variable. The generation unit 103 stores the generated prediction model in the storage device 505, for example.

The prediction unit 104 is a unit that predicts the sales quantity of the target product in a predetermined period using the demand prediction model. For example, the prediction unit 104 performs prediction by substituting an explanatory variable value of a day to be predicted into the prediction model stored in the storage device 505.

The output unit 105 outputs a prediction result by the prediction unit 104. The output unit 105 is achieved by, for example, a display device. The output unit 105 outputs the sales quantity of the target product during a predetermined period. The output unit 105 may also output information of the model such as conditional branching of the model or a model expression. The output unit 105 may output an order screen for performing order input of the target product based on the sales quantity.

The operation of the demand prediction device configured as described above will be described with reference to a flowchart of FIG. 3.

FIG. 3 is a flowchart illustrating an outline of an operation of the demand prediction device 100 according to the present disclosure. Note that the processing according to this flowchart may be executed based on program control by the processor described above. For example, the demand prediction device 100 repeats the processing according to this flowchart every time the sales quantity of the target product is predicted.

As illustrated in FIG. 3, the information acquisition unit 101 first acquires the deviation information indicating the deviation from the actual demand of the target product and the sales quantity (Step S101). Next, the correction unit 102 corrects the sales quantity based on the deviation information (Step S102). Next, the generation unit 103 generates the demand prediction model based on the learning data including the corrected sales quantity (Step S103). Next, the prediction unit 104 predicts the sales quantity of the target product in the predetermined period using the demand prediction model (Step S104). Next, the output unit 105 outputs the predicted sales quantity (Step S105). Thus, the demand prediction device 100 ends the operation.

In the demand prediction device 100 according to the present disclosure, the correction unit 102 corrects the sales quantity based on the deviation information of the target product. The generation unit 103 generates the demand prediction model based on the learning data including the corrected sales quantity. As a result, the demand prediction model can be generated using the corrected sales quantity indicating the actual demand of the target product as the learning data. Therefore, by using the demand prediction model in the present disclosure, the accuracy of the demand prediction of the product can be improved.

### Modification of First Example Embodiment

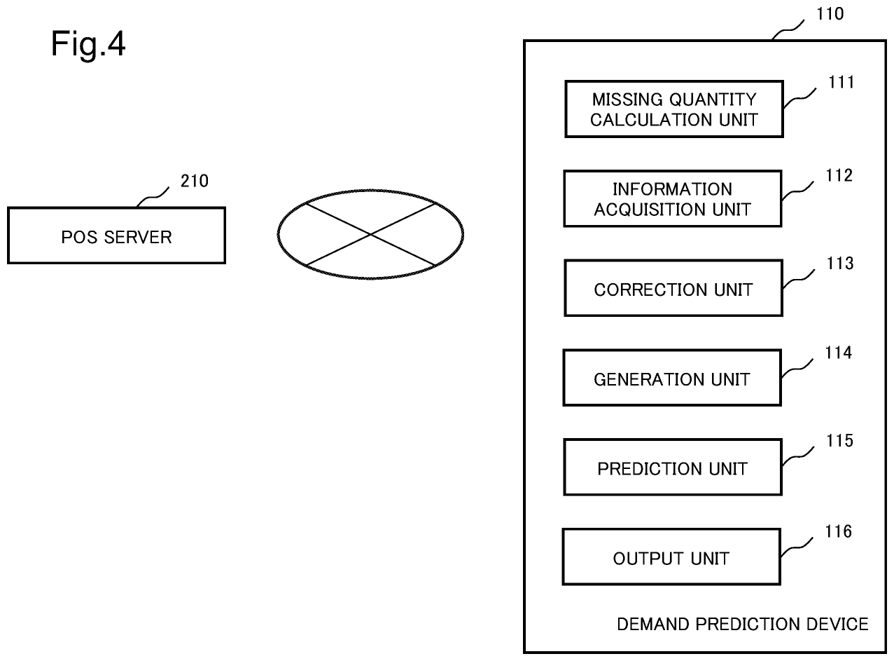

Next, a modification of the present disclosure will be described with reference to the drawings. Hereinafter, description of contents overlapping the above description will be omitted to the extent that the description of the present disclosure is not unclear. FIG. 4 illustrates a configuration including a demand prediction device 110 according to the modification of the present disclosure. As illustrated in FIG. 4, the demand prediction device 110 according to the modification of the present disclosure is different from the present disclosure in that it includes a missing quantity calculation unit 111 in addition to the configuration of the present disclosure. That is, the demand prediction device 110 according to the modification of the present disclosure includes the missing quantity calculation unit 111, an information acquisition unit 112, a correction unit 113, a generation unit 114, a prediction unit 115, and an output unit 116.

The missing quantity calculation unit 111 is a unit that calculates the quantity of missing products of the target product. In the present disclosure, the information acquisition unit 112 acquires information other than the quantity of missing products of the target product in the deviation information. When there is no stock of the target product at a predetermined time point, the missing quantity calculation unit 111 calculates the number of times of missing item processing on the business day. Specifically, the missing quantity calculation unit 111 acquires information on a stock quantity of the target product from the ordering system before the start of business, determines that a missing product has occurred when a theoretical stock quantity of the target product is 0 or less, and calculates the quantity of missing products. It is expected that a seasonal product and an end-of-sale product will not be sold even when they are in stock. Therefore, even in a case where the target product is a seasonal product or an end-of-sale product, the missing quantity calculation unit 111 may not calculate the quantity of the missing product.

Here, a method of calculating the number of missing products by the missing quantity calculation unit 111 will be described. The missing quantity calculation unit 111 calculates the quantity of missing products on each business day based on the number of customers by time zone, an average sales quantity for each day of the week of the target product, and a final sales time in a store. Specifically, the missing quantity calculation unit 111 acquires, from the POS server 210, information on the number of customers by time zone, the average sales quantity by day of the week, and the final sales time of the missing product in the store. For example, the missing quantity calculation unit 111 acquires the number of customers by time zone in the store based on the number of receipts issued by the POS terminal every several hours in the business hours of the store. The average sales quantity for each day of the week is, for example, an average value of the corrected sales quantity for each day of the week excluding a day on which a special event such as advertisement or spot sale on a flier is performed. The final sales time of the missing product is the time when the theoretical stock quantity becomes 0 or less.

First, based on the number of customers by time zone and the final sales time of the missing product, the missing quantity calculation unit 111 calculates a customer count composition ratio by time zone after the final sales time. Next, the missing quantity calculation unit 111 multiplies the average sales quantity for each day of the week by the customer count composition ratio by time zone after the final sales time, and calculates the number that should have been originally sold in the time zone after the stock runs out as the quantity of the missing product.

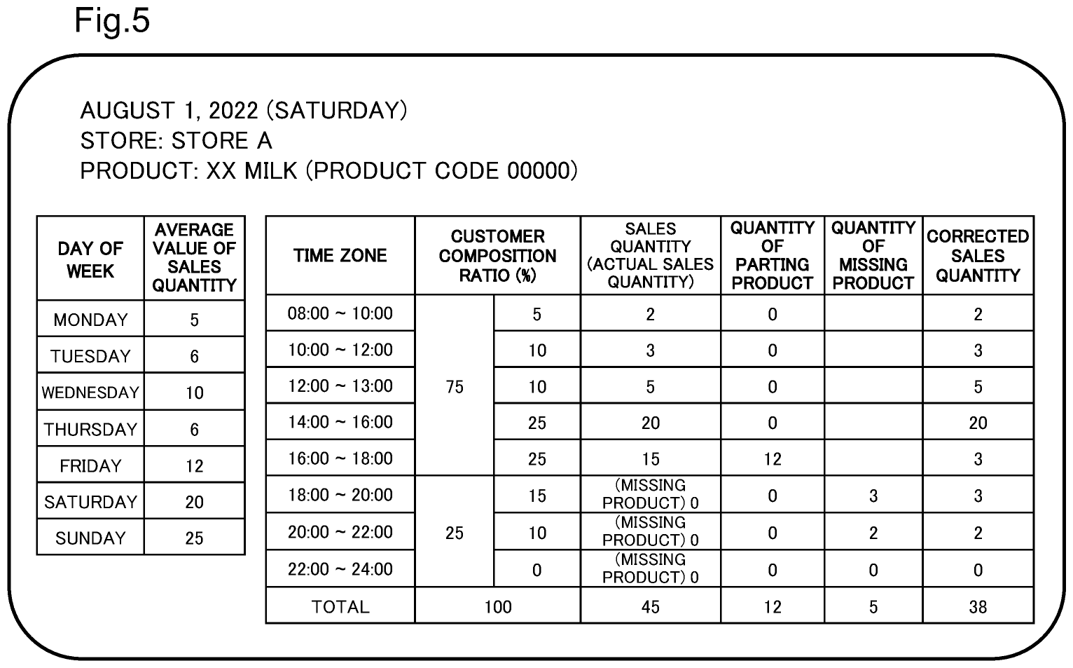

Here, a method of calculating the quantity of the missing product will be described using a specific example. FIG. 5 is an example of a screen for calculating the number of missing products in the modification of the present disclosure. This screen is, for example, a screen displayed to the user who performs the demand prediction of the target product. In FIG. 5, the quantity of the missing product is calculated for XX milk sold at store A on Saturday, Aug. 1, 2022. FIG. 5 illustrates the average sales quantity of XX milk for each day of the week at the store A, the customer count composition ratio by time zone, the sales quantity, the quantity of parting products, the quantity of missing products, and the corrected sales quantity. Here, the sales quantity refers to the actual sales quantity including the quantity of the parting products. As illustrated in FIG. 5, the average sales quantity sold on Saturday is 20. The final sales time of the XX milk is 18:00. Therefore, the customer count composition ratio by time zone after the final sales time is 25%. In this case, the missing quantity calculation unit 111 calculates the number of missing products as 20 pieces× 25%=5 pieces. The missing quantity calculation unit 111 outputs information on the calculated number of missing products to the correction unit 113.

The information acquisition unit 112 acquires information on the quantity of the parting products of the XX milk from the POS server 210, and outputs the information to the correction unit 113. The correction unit 113 corrects the sales quantity based on the quantity of the missing products and the quantity of the parting products. In the example of FIG. 5, the sales quantity of XX milk on Saturday, Aug. 1, 2022 is 45. The quantity of the parting products is 12 out of the sales quantity of 45. The correction unit 113 corrects the actual sales quantity using the quantity of the missing products and the quantity of the parting products. That is, the correction unit 113 corrects the sales quantity such that 45 pieces in the actual sales quantity+5 pieces in the quantity of missing products−12 pieces in the quantity of parting products=38 pieces.

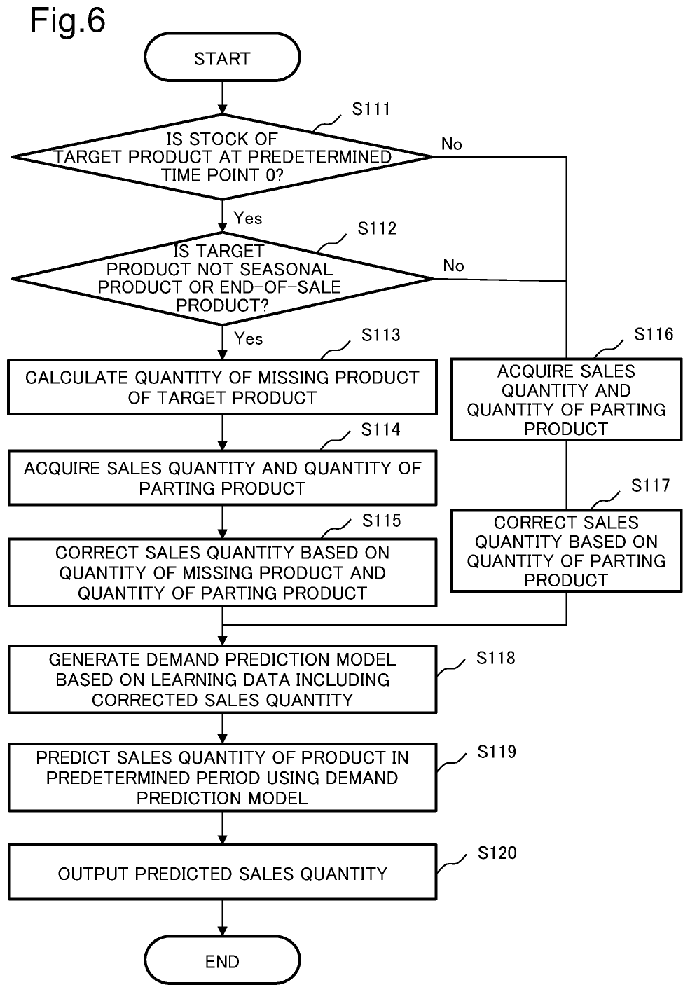

The operation of the demand prediction device 110 configured as described above will be described with reference to the flowchart of FIG. 6.

FIG. 6 is a flowchart illustrating an outline of an operation of the demand prediction device 110 in the modification of the present disclosure. Note that the processing according to this flowchart may be executed based on program control by the processor described above. The demand prediction device 110 executes the processing according to this flowchart, for example, at the timing of predicting the sales quantity for the order work of the target product.

As illustrated in FIG. 6, first, when the stock quantity of the target product acquired from the ordering system at a predetermined time point is 0 (Step S111; YES) and the target product is not the seasonal product or the end-of-sale product (S112; YES), the missing quantity calculation unit 111 calculates the quantity of the missing products of the target product (Step S113). Next, the information acquisition unit 112 acquires the sales quantity of the target product and the quantity of the parting product (Step S114). Next, the correction unit 102 corrects the sales quantity based on the quantity of the missing products of the target product and the quantity of the parting products (Step S115).

Meanwhile, when the stock quantity of the target product acquired from the ordering system at the predetermined time point is not 0 (S111; NO), or when the target product is the seasonal product or the end-of-sale product (S112; NO), the missing quantity calculation unit 111 does not calculate the quantity of the missing product and outputs the information to the information acquisition unit 112. Next, the information acquisition unit 112 acquires the sales quantity of the target product and the quantity of the parting product (Step S116). Next, the correction unit 113 corrects the sales quantity based on the quantity of the parting products (Step S117).

The processing after Step S118 is similar to Steps S103 to S105 in the present disclosure. That is, the generation unit 114 generates the demand prediction model based on the learning data including the corrected sales quantity (Step S118). Next, the prediction unit 115 predicts the sales quantity of the target product in the predetermined period using the demand prediction model (Step S119). Next, the output unit 116 outputs the predicted sales quantity (Step S120). Thus, the demand prediction device 110 ends the operation.

In the modification of the present disclosure, when there is no stock of the target product at a predetermined time point, the missing quantity calculation unit 111 calculates the number of times of the missing item processing on the business day. As a result, since the quantity of the missing product is calculated only when necessary, the learning data can be efficiently acquired. The missing quantity calculation unit 111 uses the number of customers by time zone in the store, which is an index common to all the products, to calculate the quantity of the missing product of the target product (the sales quantity by time zone after the final sales time). As a result, the calculation for calculating the quantity of missing products can be simplified.

Although the present invention has been described with reference to the exemplary embodiments, the present invention is not limited to the exemplary embodiments. Various modifications that can be understood by those skilled in the art can be made to the configuration and details of the present invention within the scope of the present invention.

For example, although the plurality of operations are described in order in the form of a flowchart, the order of description does not limit the order of executing the plurality of operations. Therefore, when each example embodiment is implemented, the order of the plurality of operations can be changed within a range that does not interfere in content.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents. Further, it is noted that the inventor's intent is to retain all equivalents of the claimed invention even if the claims are amended during prosecution.

The model used for the demand prediction of the product uses the sales quantity of the product actually sold in the store as the learning data. However, the actual sales quantity of the product does not include a demand or the like that could not be sold due to the stock of the product running out. Therefore, the sales quantity of the product does not accurately represent the demand of the product.

An example of the effect of the present disclosure is to provide a demand prediction device capable of improving the accuracy of demand prediction of products.

1. A demand prediction device comprising:
a memory storing instructions; and
at least one processor configured to execute the instructions to:
acquire deviation information indicating a deviation from an actual demand of a target product and a sales quantity;
correct the sales quantity based on the deviation information; and
generate a demand prediction model based on learning data including the corrected sales quantity.

2. The demand prediction device according to claim 1, wherein the at least one processor is further configured to execute the instructions to:
predict a sales quantity of the target product in a predetermined period using the demand prediction model; and
output the predicted sales quantity.

3. The demand prediction device according to claim 1, wherein the deviation information is a quantity of a parting product or a missing product of the target product.

4. The demand prediction device according to claim 3, wherein the parting product is a product sold at a predetermined discount rate or more from a normal price.

5. The demand prediction device according to claim 3, wherein the at least one processor is further configured to execute the instructions to:
calculate the quantity of the missing product based on the number of customers by time zone in a store, an average sales quantity of the target product by day of a week, and a final sales time.

6. The demand prediction device according to claim 5, wherein the at least one processor is further configured to execute the instructions to:
when there is no stock of the target product at a predetermined time point, calculate the quantity of the missing product on a business day.

7. A demand prediction method for causing a computer to execute:
acquiring deviation information indicating a deviation from an actual demand of a target product and a sales quantity;
correcting the sales quantity based on the deviation information; and
generating a demand prediction model based on learning data including the corrected sales quantity.

8. A non-transitory computer-readable recording medium that records a program for causing a computer to execute:
acquiring deviation information indicating a deviation from an actual demand of a target product and a sales quantity;
correcting the sales quantity based on the deviation information; and
generating a demand prediction model based on learning data including the corrected sales quantity.
